(19) United States
(12) Patent Application Publication
(10) Pub. No.: US 2015/0104671 A1
(43) Pub. Date: Apr. 16, 2015

(54) POWER BATTERY

(71) Applicants: DongGuan Amperex Technology Limited, Dongguan (CN); NingDe Amperex Technology Limited, Ningde City (CN)

(72) Inventors: Heng Zhang, Ningde City (CN); Rulai Cai, Ningde City (CN); Quankun Li, Ningde City (CN); Qiong Qu, Ningde City (CN)

(73) Assignees: DongGuan Amperex Technology Limited, Dongguan (CN); NingDe Amperex Technology Limited, Ningde City (CN)

(21) Appl. No.: 14/055,223

(22) Filed: Oct. 16, 2013

(51) Int. Cl. H01M 2/34

(52) U.S. Cl. CPC H01M 2/34; H01M 2200/00; H01M 2220/10; H01M 2220/20; H01M 2220/30
USPC 429/7

(57) ABSTRACT

This invention belongs to the field of power battery technologies, and in particular, to a power battery. The power battery comprises a battery shell, a cell accommodated in the battery shell, an electrolyte filled inside the battery shell, and a top cover assembled in a sealed way to the battery shell; a cathode tab and an anode tab are positioned on a front end of the cell; and a cathode transit plate is positioned between the top cover and the cathode tab, wherein a melting region is positioned on the cathode transit plate. Compared with the prior art, this invention, by providing the melting region on the cathode transit plate, is capable of effectively separating the top cover from the cell thereby protecting the top cover from damages when an inner short-circuit or an outer short-circuit occurs on the battery; moreover, the melting region forms a fragile place for a current, and when a large current is generated due to an inner short-circuit or an outer short-circuit of the battery, the region where the melting region is located may melt immediately, where a melting position is accurate and sensitivity is high, thereby greatly improving safety performance of the battery. In addition, this invention has a simple structure, may be implemented easily, and may be applied for industrial production.

### TECHNICAL FIELD OF THE INVENTION

This invention relates to the field of power battery technologies, and in particular, to a power battery having high safety performance.

### BACKGROUND OF THE INVENTION

With the development of modern society and the enhancement of people's environmental protection awareness, a rechargeable secondary battery is selected as a power source for more and more devices, such as a mobile phone, a notebook computer, an electric tool, and an electric vehicle, which provides a broad space for application and development of a rechargeable secondary battery.

An electric vehicle, an energy storage power station, and the like generally need to use a power battery having high capacity as a power source. These power batteries, besides the high capacity, should also have good safety performance and a long cycle life, so as to meet use criteria and satisfy people's requirements.

In the prior art, a top cover of a power battery generally is directly connected to a tab of a cell electrically. Once an inner short-circuit or an outer short-circuit occurs on the power battery, the battery discharges a large current internally or externally. The discharge of the large current causes a high temperature, where the high temperature is likely to damage the top cover, resulting in that a flammable gas inside the battery is ejected from a high-temperature point of the top cover and causing a safety accident.

In order to improve this situation, the patent CN201020520194 discloses a power battery with a transit plate positioned between a top cover and a cell. Because the provision of the transit plate may separate the battery top cover from the cell, when an inner short-circuit occurs on the battery, a high temperature caused by a discharge of a large current inside the cell is away from the top cover, thereby protecting the top cover from damages; when an outer short-circuit occurs on the battery, the cell discharges a large current externally so that the transit plate melts and breaks, thereby protecting the top cover from damages.

However, in mentioned patent, the whole transit plate has uniform thickness; therefore, when an inner short-circuit or an outer short-circuit occurs on a battery, the whole transit plate may melt at any position, where a melting position is inaccurate and sensitivity is low. When the melting position is close to a tab, the tab may be damaged; when the melting position is close to a top cover, even the top cover may be damaged to a certain extent, where safety performance is not satisfactory.

In view of this, it is absolutely necessary to provide a power battery having higher safety performance.

### SUMMARY OF THE INVENTION

This invention aims to, with respect to the defects of the prior art, provide a power battery having higher safety performance, thereby overcoming the defects of unsatisfactory safety performance of a power battery in the prior art.

To fulfill such an objective, this invention uses the following technical solution:

A power battery includes a battery shell, a cell accommodated in the battery shell, an electrolyte filled inside the battery shell, and a top cover assembled in a sealed way to the battery shell, where a cathode tab and an anode tab are positioned on a front end of the cell; a cathode transit plate is positioned between the top cover and the cathode tab; and a melting region is positioned on the cathode transit plate.

As an improvement of the power battery according to the invention, the melting region is positioned at a current-flowing place of the cathode transit plate.

As an improvement of the power battery according to the invention, the melting region is provided as a through hole.

As an improvement of the power battery according to the invention, a cross section of the through hole is circle-shaped.

As an improvement of the power battery according to the invention, the melting region is provided as a concave groove.

As an improvement of the power battery according to the invention, a cross section of the concave groove is rectangle-shaped.

As an improvement of the power battery according to the invention, an anode transit plate is positioned between the top cover and the anode tab.

As an improvement of the power battery according to the invention, the thickness of the cathode transit plate is 0.1-1.0 mm.

As an improvement of the power battery according to the invention, an area of the melting region is 1-15% of a total area of the cathode transit plate.

As an improvement of the power battery according to the invention, the cathode transit plate is welded respectively to the top cover and the cathode tab.

Compared with the prior art, this invention, by providing the melting region on the cathode transit plate positioned between the top cover and the cell, is capable of effectively separating the battery top cover from the cell thereby protecting the top cover from damages when an inner short-circuit or an outer short-circuit occurs on the battery, so as to prevent a flammable gas inside the battery from leaking from the damage place of the top cover and burning; moreover, the melting region forms a fragile place for a current, and when a large current is generated due to an inner short-circuit or an outer short-circuit of the battery, the region where the melting region is located may melt immediately, where a melting position is accurate, and sensitivity is high, thereby greatly improving safety performance of the battery and protecting the battery tabs from damages. In addition, this invention has a simple structure, may be implemented easily, and may be applied for industrial production.

### BRIEF DESCRIPTION OF DRAWINGS

FIG. 1 is a sectional view of the invention; and

FIG. 2 is a schematic structural diagram of a cathode transit plate according to the invention.

Where: 1-battery shell, 11-plastic bracket, 2-cell, 21-cathode tab, 22-anode tab, 3-top cover, 31-cathode post, 32-anode post, 33-explosion-proof valve, 4-cathode transit plate, 41-melting region, 5-anode transit plate.

### DETAILED DESCRIPTION OF PREFERRED EMBODIMENTS

The following further describes this invention with reference to accompanying drawings and specific embodiments; however, a specific implementation mode of the invention is not limited thereto.

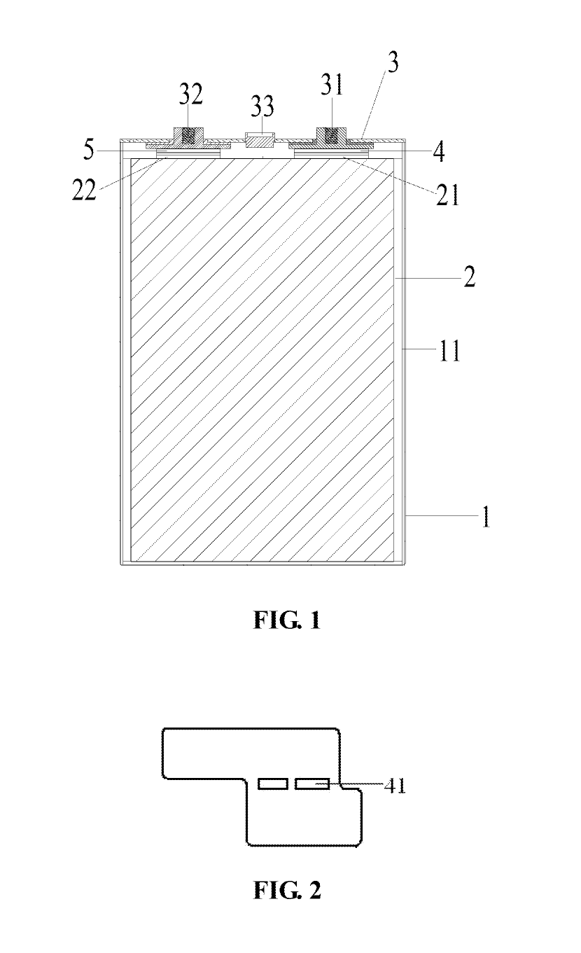

As shown in FIG. 1 and FIG. 2, a power battery according to the invention includes a battery shell 1, a cell 2 accommodated in the battery shell 1, an electrolyte filled inside the battery shell 1, and a top cover 3 assembled in a sealed way to the battery shell 1, where a cathode tab 21 and an anode tab 22 are positioned on a front end of the cell 2, a cathode transit plate 4 is positioned between the top cover 3 and the cathode tab 21, and a melting region 41 is positioned on the cathode transit plate 4. The place on the cathode transit plate 4 except for the melting region 41 may be referred to as a main region. The melting region 41 is different from the main region in that: the thickness of the transit plate of the melting region 41 is smaller than the thickness of the transit plate of the main region; the thickness of the transit plate of the melting region 41 may be 0; and when an inner short-circuit or an outer short-circuit occurs on the battery, the melting region 41 becomes a fragile region for a current and melts and breaks immediately, which has features of an accurate melting position and high sensitivity. After the melting region 41 melts and breaks, the cell 2 and the top cover 3 are separated, which protects the top cover 3 from damages thereby preventing a flammable gas inside the battery from leaking from the damage place of the top cover 3 and burning, so as to improve safety performance of the battery.

A cathode post 31 and an anode post 32 are positioned on the top cover 3. A material of the battery shell 1 is stainless steel or aluminum, which has good corrosion resistance and sufficient strength. In order to further protect the battery shell 1 from corrosion, a plastic bracket 11 may be positioned between the battery shell 1 and the cell 2. In order to enhance explosion-proof capacity of the battery, an explosion-proof valve 33 may further be positioned on the top cover 3. The cathode transit plate 4 is made of a metal foil (such as an aluminum foil, a copper foil, and a nickel foil) having good electric conduction performance and heat conduction performance, and the cathode transit plate 4 may separate the cathode tab 21 from the top cover 3.

In addition, an anode transit plate 5 is positioned between the top cover 3 and the anode tab 22, thereby separating the anode tab 22 from the top cover 3. In other words, the cathode tab 21 and the anode tab 22 of the cell 2 of the invention, instead of being directly connected to a cathode post 31 and an anode post 32 of the top cover 3 electrically, are connected to the top cover 3 through the cathode transit plate 4 and the anode transit plate 5 electrically.

The melting region 41 is positioned at a current-flowing place of the cathode transit plate 4. The cathode transit plate 4 is welded respectively to the top cover 3 and the cathode tab 21. Therefore, the cathode transit plate 4 may be divided into a portion (which is referred to as an upper portion) welded to the top cover 3 and a portion (which is referred to as a lower portion) welded to the cathode tab 21, and the current-flowing place is a place where the upper portion and the lower portion are connected.

The melting region 41 is provided as a through hole, where the provision of the through hole reduces a cross section area of the place where the through hole is located, thereby forming a fragile current-flowing position.

A cross section of the melting region 41 is circle-shaped.

The melting region 41 is provided as a concave groove, where the provision of the concave groove reduces a cross section area of the place where the through hole is located, thereby forming a fragile current-flowing position.

The cross section of the melting region 41 is rectangle-shaped, and may also be in a shape such as “ [symbol] ”, “ [symbol] ”, or “ [symbol] ”.

The thickness of the cathode transit plate 4 is 0.1-1.0 mm, which not only ensures certain strength and weldability for the cathode transit plate 2, but also reduces material costs.

An area of the melting region 41 is 1-15% of a total area of the cathode transit plate 4. A melting region 41 having a too large area may reduce the strength of the cathode transit plate which is likely to be broken; and a melting region 41 having a small area is improper for manufacturing the melting region 41.

Compared with the prior art, this invention, by providing the melting region 41 on the cathode transit plate 4 positioned between the top cover 3 and the cell 2, is capable of effectively separating the battery top cover 3 from the cell 2 thereby protecting the top cover 3 from damages when an inner short-circuit or an outer short-circuit occurs on the battery, so as to prevent a flammable gas inside the battery from leaking from the damage place of the top cover 3 and burning; moreover, the melting region 41 forms a fragile place for a current, when a large current is generated due to an inner short-circuit or an outer short-circuit of the battery, the region where the melting region 41 is located may melt and break immediately, where a melting position is accurate, and sensitivity is high, thereby greatly improving safety performance of the battery and protecting the battery tabs from damages. In addition, this invention has a simple structure, may be implemented easily, and may be applied for industrial production.

According to what is disclosed and revealed herein, persons skilled in the field of the invention can make appropriate variations and modifications to the foregoing implementation modes. Therefore, the invention is not limited to the specific embodiments disclosed and described above, and the modifications and variations of the invention shall fall within the protection scope specified in the claims of the invention. In addition, although specific terms are employed herein, the terms are merely for ease of description and do not constitute any limitation on the invention.

What is claimed is:

1. A power battery, comprising a battery shell, a cell accommodated in the battery shell, an electrolyte filled inside the battery shell, and a top cover assembled in a sealed way to the battery shell, wherein a cathode tab and an anode tab are positioned on a front end of the cell, and a cathode transit plate is positioned between the top cover and the cathode tab, wherein: a melting region is positioned on the cathode transit plate.

2. The power battery according to claim 1, wherein: the melting region is positioned at a current-flowing place of the cathode transit plate.

3. The power battery according to claim 1, wherein: the melting region is provided as a through hole.

4. The power battery according to claim 3, wherein: a cross section of the through hole is circle-shaped.

5. The power battery according to claim 1, wherein: the melting region is provided as a concave groove.

6. The power battery according to claim 5, wherein: a cross section of the concave groove is circle-shaped.

7. The power battery according to claim 1, wherein: an anode transit plate is positioned between the top cover and the anode tab.

8. The power battery according to claim 1, wherein: thickness of the cathode transit plate is 0.1-1.0 mm.

9. The power battery according to claim 1, wherein: an area of the melting region is 1-15% of a total area of the cathode transit plate.

10. The power battery according to claim 1, wherein: the cathode transit plate is welded respectively to the top cover and the cathode tab.
